(19) United States
(12) Patent Application Publication
(10) Pub. No.: US 2007/0067346 A1
(43) Pub. Date: Mar. 22, 2007

(54) INFORMATION PROCESSING APPARATUS USED FOR OPERATION MANAGEMENT OF AN IMAGE FORMING APPARATUS

(75) Inventor: Nobuyoshi KAKIGI, Kanagawa (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/470,208

(22) Filed: Sep. 5, 2006

Related U.S. Application Data
(62) Division of application No. 10/414,099, filed on Apr. 16, 2003, now abandoned.

(30) Foreign Application Priority Data
Apr. 16, 2002 (JP) 2002113074
Mar. 18, 2003 (JP) 200373595

(51) Int. Cl. G06F 17/00

(52) U.S. Cl. 707/104.1

(57) ABSTRACT

A sever records a history of designation of a function which is inexecutable by a printer. Additional function information indicating a function which is addable to the printer is stored in the database. The additional function information is retrieved from the database according to the inexecutable function being designated at the printer, and the additional function information is presented to a user on a display. The user can then choose to provide the printer with the additional function information so that the inexecutable function can be added to the printer.

This application is a division of application Ser. No. 10/414,099, filed Apr. 16, 2003.

### BACKGROUND OF THE INVENTION

1. Field of the Invention

The present invention relates to an operation management technique which uses a network or other communication line (a communications medium) to present an optimum proposal tailored to a problem in an image forming apparatus, such as a printer or a copying machine, which is on a user apparatus side.

2. Related Background Art

Up until now, product replacement, addition of various optional devices, addition of systems, and the like were largely performed by appeals made in TV commercials, appeals made in newspapers and advertisements, appeals made through negotiations and explanations conducted by salespeople, and the like, as depicted in FIG. 18. Further, it goes without saying that pursuit of expandability through research and development was indispensable.

Further, there were also cases where the user felt a problem actually during use, and used a telephone, an email, a FAX, or other such means to make an inquiry to a service center or a dealer, and the product replacement or addition was performed through exchanges at that time.

Further, in a configuration for effectively presenting an action printer to the user, for example, according to Patent Document 1 (JP 10-229396 A), in a case where trouble occurs in the status of a service operation, a judgment is automatically made regarding which portion causes the trouble, a countermeasure method is proposed, and a report is also automatically provided to the user who is suffering the trouble.

Further, according to Patent Document 2 (JP 10-283209 A), running information regarding a usage rate of a memory and a CPU of a computer is collected, and an optimum product determined by this information is introduced to the user.

Further, according to Patent Document 2, a proposal is made to improve specifications of parts which are already provided to a host computer on the user side, in response to the usage condition of the computer.

However, in the above-mentioned conventional techniques known in Patent Documents 1 and 2 and the like, problems caused such as are described below.

Once the image forming apparatus was sold to the user, it was difficult to obtain sufficient feedback regarding problems and the like occurring in the image forming apparatus on the user side. Unless the user performed an inquiry or some other action, the content of the problem information could not be learned.

Also, when the user performed the inquiry by means of an email or a FAX, depending on the time the inquiry was made, the email or the FAX was not read until the next day or the day after vacation. Thus, there were many cases where the inquiry could not be processed immediately.

Further, since handling the above-mentioned inquiry was always performed involving a human being, considerable personnel costs were required.

Further, according to Patent Document 1, the cause of the error is determined, and the countermeasure method for resolving the error is merely presented. Thus, it was imagined that the same trouble would continue subsequently.

Further, according to Patent Document 2, ideal specifications for equipment that is already provided to the host computer were merely presented to the user. The optimum operation was not presented in response to the problem occurring in the image forming apparatus being used on the user side.

### SUMMARY OF THE INVENTION

The present invention has been made to solve the above-mentioned problems in the conventional techniques, and therefore has as an object to learn an operation method being used by the user, and error information, to quickly provide a proposal for better operation.

In order to attain the above-mentioned object, according to the present invention, there is provided an information processing apparatus for performing processing for operation, management which can connect to a user apparatus via a communications medium, the apparatus including:

a database for storing a proposal for optimum operation of an image forming apparatus which is forming an image on a recording material;

receiving means for receiving problem information of an image forming apparatus, which is notified from the user apparatus; and

presenting means for presenting the optimum operation proposal for the image forming apparatus, which is retrieved from the database based on the problem information received by the receiving means.

According to the present invention, there is provided a processing method for operation management using an information processing apparatus capable of connecting to a user apparatus via a communications medium, the method comprising the steps of:

the information processing apparatus receiving the problem information of an image forming apparatus which is forming an image on a recording material, the problem information which is notified from the user apparatus; and

the information processing apparatus presenting a proposal for optimum operation of an image forming apparatus, which is selected from a database storing the proposal for optimum operation of the image forming apparatus, based on the received problem information.

According to the present invention, there is provided a program for executing operation management processing using an information processing apparatus capable of connecting to a user apparatus via a communications medium, in which the program makes the information processing apparatus execute the following:

processing for receiving the problem information of an image forming apparatus which is forming an image on a recording material, the problem information which is notified from the user apparatus; and

processing for presenting a proposal for optimum operation of an image forming apparatus, which is selected from a database storing the proposal for optimum operation of the image forming apparatus, based on the received problem information.

According to the present invention, there is provided a storage medium storing a program for executing optimum operation processing using an information processing apparatus capable of connecting to a user apparatus via a communications medium, in which the program makes the information processing apparatus execute the following:

processing for receiving the problem information of an image forming apparatus which is forming an image on a recording material, the problem information which is notified from the user apparatus, and

processing for presenting a proposal for optimum operation of an image forming apparatus, which is selected from a database storing the proposal for optimum operation of the image forming apparatus, based on the received problem information.

### BRIEF DESCRIPTION OF THE DRAWINGS

In the accompanying drawings:

FIG. 1 is a conceptual view for explaining an operation management system, up to an optimum proposal for operation and completion of a purchase request, in accordance with Embodiment 1;

FIG. 2 is a block diagram showing an internal configuration of a server, in accordance with Embodiment 1;

FIG. 3 is an event tracing diagram for explaining the operation management system, up to the optimum proposal for operation of a laser printer and completion of the purchase request, in accordance with Embodiment 1;

FIG. 4 is a diagram showing an example of forwarded information which is forwarded to a service center, in accordance with Embodiment 1;

FIG. 5 is a view showing an example of a DI screen for performing the optimum proposal, in accordance with Embodiment 1;

FIG. 6 is a view showing another example of the DI screen for performing the optimum proposal, in accordance with Embodiment 1;

FIG. 7 is a diagram showing examples of proposals in accordance with Embodiment 1;

FIG. 8 is a flowchart for explaining diagnosis processing at the service center, in accordance with Embodiment 1;

FIG. 9 is a diagram for explaining details of the forwarded information, in accordance with the present invention;

FIGS. 10A and 10B are diagrams for explaining details of a database at the service center, in accordance with the present invention;

FIG. 11 is a view showing an example of a UI screen for performing a user registration to receive an automatic service, in accordance with Embodiment 1;

FIG. 12 is an event tracing diagram for explaining an operation management system, up to the optimum proposal for operation and completion of the purchase request, in accordance with Embodiment 2;

FIG. 13 is a conceptual view for explaining an operation management system, up to an optimum proposal for operation of a copying machine and a facsimile machine (FAX), and completion of a purchase request, in accordance with Embodiment 3;

FIG. 14 is an event tracing diagram for explaining the operation management system, up to the optimum proposal for operation of the copying machine and the facsimile machine (FAX) and completion of the purchase request, in accordance with Embodiment 3;

FIG. 15 is an example of the optimum proposal, presented via the FAX in accordance with Embodiment 3;

FIG. 16 is an example of the optimum proposal, presented on an operation panel in accordance with Embodiment 3;

FIG. 17 is a conceptual view for explaining an operation management system, up to an optimum proposal for operation and completion of a purchase request, in accordance with Embodiment 5; and

FIG. 18 is a diagram for explaining a system, up to resolution of trouble which has occurred, in accordance with related background arts.

### DETAILED DESCRIPTION OF THE PREFERRED EMBODIMENTS

Hereinafter, detailed explanation is given regarding embodiments of the present invention, with reference to the drawings.

### Embodiment 1

In accordance with Embodiment 1, explanation is given regarding an operation management system in a system using a laser printer. However, the scope of the present invention is not limited to the described example. For example, an image forming apparatus forming an image on a recording material is not restricted to the laser printer. Rather, the present invention can be applied in various types of image forming apparatuses, including a digital multifunction machine, a copying machine, a facsimile machine, an injection printer, and the like.

[Construction of the Operation Management System Used With The Laser Printer]

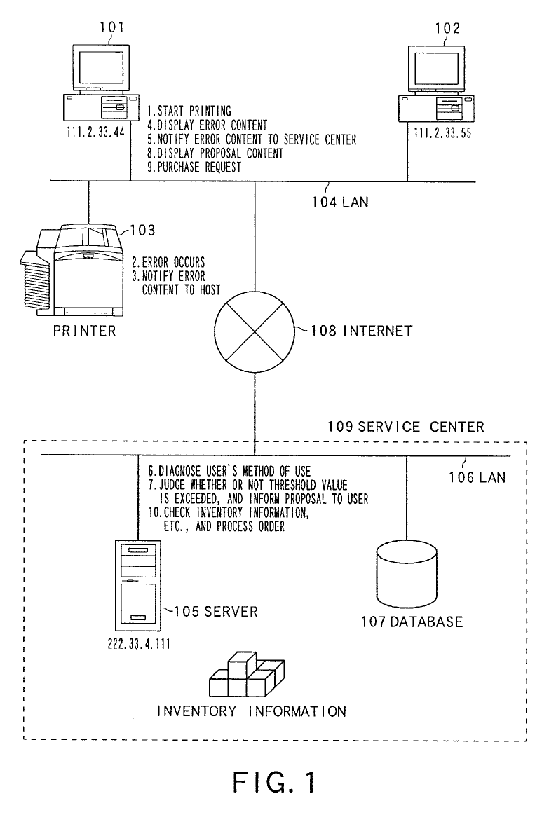

FIG. 1 is a conceptual view of one example of a system for proposing an optimum operation for a laser printer according to Embodiment 1, and shows processing up to an automatic proposal.

First, explanation is given regarding a summary of the operation management, according to this embodiment, with reference to FIG. 1. In FIG. 1, a host 101 serving as a user apparatus which is a computer having an Internet protocol (IP) address “111.2.33.44”, a host 102 serving as a user apparatus which is a computer having an IP address “111.2.33.55”, and a printer 103 serving as the image forming apparatus, are configured to the same LAN 104.

Further, a server 105 serving as an operation management server which is an information processing apparatus having an IP address “222.33.4.111”, is configured on a LAN 106 inside a service center.

Further, each of LANs 104 and 106 is connected via the Internet 108, which serves as a communications medium.

The LAN 104 is an example of a system built by the user, and the LAN 106 is a system configured at a service center for computer apparatuses.

Note that, the following explanation will be given of an example with only one user system, but this is to simplify the explanation. Of course, many user systems can connect to the service center 109 via the Internet 108.

[Example of Specific Configuration of the Server]

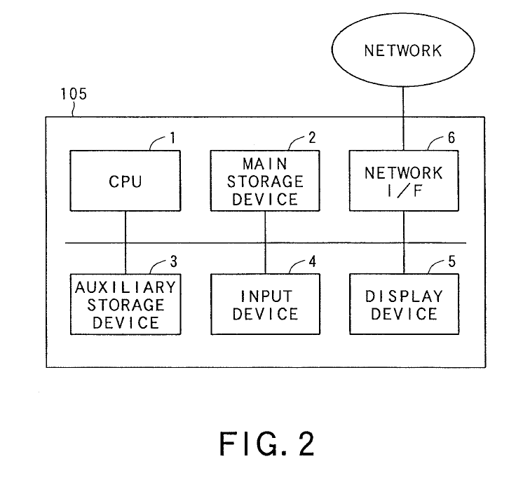

FIG. 2 is a block diagram showing a hardware construction of the server 105.

As shown in the diagram, the server 105, in summary, is constructed having a central processing unit (CPU) 1, a main storage device 2, an auxiliary storage device 3, an input device 4, a display device 5, and a network I/F 6. This construction can be realized using, for example, a personal computer, a workstation, or other such general-purpose computers.

The CPU 1 is a unit which, according to timing of clock signals transmitted from a clock device (not shown in the diagram), reads, to the main storage device 2, data which is stored in the auxiliary storage device 3, data inputted from the input device 4, data received via the network I/F 6, or a program stored in the auxiliary storage device 3, or a program received via the network I/F6, and performs computational processing based on the content which is read.

Further, based on a result from this computational processing, the CPU 1 performs control of the internal and external apparatuses such as the main storage device 2, the auxiliary storage device 3, the display device 5 and the network I/F 6, and the like.

The main storage device 2 is a component alternatively called a memory, and it indicates addressable all storage space used to execute program commands on the server 105. The main storage device 2 is mainly constituted by a high-speed semiconductor storage element such as a random access memory (RAM), and temporarily stores/holds the program and data which the CPU 1 executes.

The auxiliary storage device 3 is a component for supplementing the storage capacity of the main storage device 2. For example, it can be a magnetic disk device (a hard disk, a Floppy (registered trademark) disk, etc. ), an optical disk device (a CD-ROM, a CD-R, a CD-R/W, a DVD-ROM, a DVD-RAM, etc.), an optical magnetic disk device (an MO, etc.), a semiconductor disk device (such as a memory card), or the like.

The input device 4 is a device for inputting various types of data. For example, it can be a keyboard, a mouse, a pointing device, a touch panel, a CCD camera, a card reader, a paper-tape reader, a magnetic tape device, or the like.

The display device 5 is a device for outputting the computation results and the like from the CPU 1. For example, it can be a CRT, a liquid crystal display, a plasma display, or the like.

The network I/F 6 is a device for connecting the server 105 to a LAN, a WAN, the Internet, or other such computer networks. For example, it can be a network adapter, a TA, a modern, or the like.

Here, the above-mentioned devices are mutually connected by means of an address bus or a data bus.

Further, the numbers of main storage devices 2 and auxiliary storage devices 3 are not limited to 1 each. Rather, the number of devices may be determined arbitrarily. As the numbers of main storage devices 2 and auxiliary storage devices 3 increase, the server's fault-tolerance is improved equally.

Note that, the various programs for making the server 105 execute the processing described below, are stored in the auxiliary storage device 3, and they are read to the main storage device 2 at the execution time. Therefore, the storage media on which the programs for making the server 105 execute the processing described below are recorded, fall under at least one of the above-mentioned main storage device 2 and the auxiliary storage device 3.

Further, in the explanations described below, provided no particular restriction is made, the CPU 1 mainly executes the processing on the server 105. Further, the program for making the server 105 execute the processing mentioned below may be constructed as a single program, or it may be realized by combining a plurality of module programs.

[Example of Specific Configuration of the Hosts]

The hosts 101 and 102, similarly to the server 105 shown in FIG. 2, are constituted including, in summary, the CPU 1, the main storage device 2, the auxiliary storage device 3, the input device 4, the display device 5, and the network I/F 6. Since those components achieve similar functions/actions as the components constituting the server 105 shown in FIG. 2, detailed explanations thereof are omitted.

[Procedure of the Operation Management]

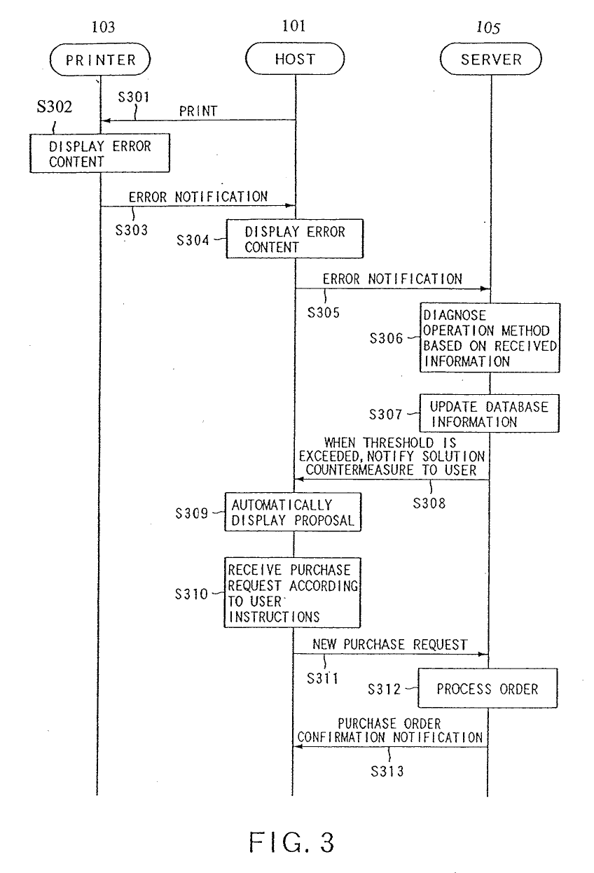

FIG. 3 is an event-tracing diagram for explaining a flow up to the automatic proposal regarding the optimum operation for the laser printer, using the operation management system in FIG. 1.

According to the system shown in FIG. 1, in order for the user to perform the printing, print data is sent from the host 101 to the connected printer 103. With reference to FIG. 3, explanation will be made of an example of the procedure of the operation management via the Internet 108 in a case where trouble has occurred upon executing the printing processing.

First, the user performs a print instruction from the host 101, to send the data to the printer 103 (step 8301).

When this occurs, for example, in a case where a printing error or other such troubles occur at the printer 103 during printing execution and it becomes impossible to perform printing, the content of the error which has occurred is displayed on a panel of the printer 103 (step 8302) .

Then, the printer 103 informs the host 101 of the trouble content which has occurred as an error notification (step 8303).

Next, the host 101 which has received the trouble notification displays detailed information about the content of the trouble which, for example, cannot be shown on the panel display of the printer 103, on a window of the display device provided to the host 101, so that the content of the trouble that has occurred can be easily understood by the user (step 8304).

Note that, in addition to displaying the above-mentioned trouble content on the display device, it can also be transmitted to the user by means of an audio device provided to the host 101.

The processing up to this point is processing which is generally performed with respect to trouble, even in the conventional printer or other such printing systems.

A characteristic of this embodiment is processing described in step 8305 and its subsequent steps. By performing the processing in step 8305 and the subsequent steps, the operation methods used by as many users as possible and their problems can be learned unitarily, and based on that information a diagnosis can be made regarding the operation methods used by the users and the proposal for optimum operation can be made automatically, and a purchase request becomes possible via the network to realize the optimum operation. As a result, the convenience for the user can be increased.

Namely, after step 8304, the host 101 which has received the error notification accesses the service center 109 and notifies the server 105 about the occurrence of trouble as the problem information (step 8305). The notification at step 8305 may be performed automatically, or may be performed in response to an instruction from the user (semi-automatically).

The trouble notification is sent together with the error content that has been received from the printer 103.

Next, the server 105 at the service center 109 which has received the error notification diagnoses the operation method used by the user, based on the received information (step 8306).

Then, database information of the given user is updated based on the diagnosis (step 8307).

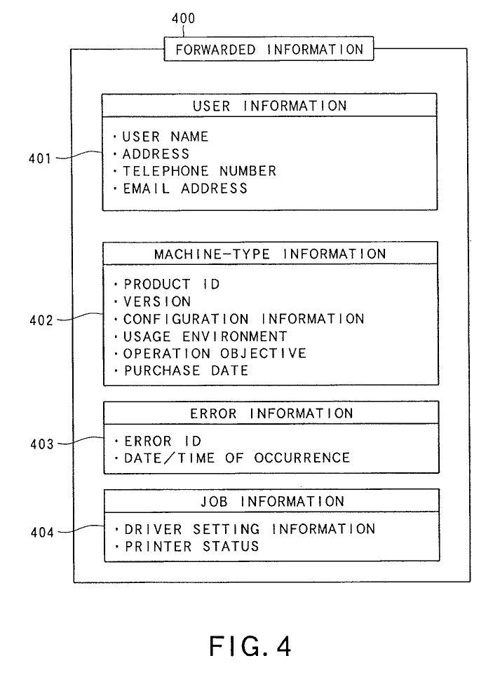

Here, forwarded information 400 sent as the problem information at step 8305 from the user side to the service center 109, includes, for example, user information 401, machine-type information 402, error information 403, job information 404, and the like as shown in FIG. 4.

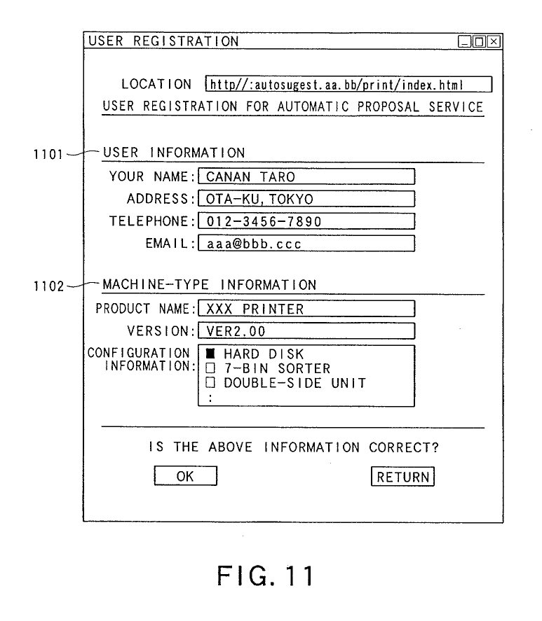

The user information 401 is used mainly used as a link to the user information in the database 107, and as information on a return address to which the diagnosis results are sent. A “user name”, an “address”, a “telephone number”, and an “email address” in the user information 401, correspond respectively to “Your name”, “Your address” “Your telephone number” and “Your email address” indicated by reference numeral 1101 in FIG. 11 described below.

The machine-type information 402 is used as material for diagnosing whether or not the operation is optimal, mainly with respect to the received operation information. A “product 10”, “version” and “configuration information” in the machine-type information 402 correspond respectively to a “product name”, a “version”, and “configuration information” indicated by reference numeral 1102 in FIG. 11.

Further, the error information 403 and the job information 404 are used as information for accessing a database 107 relating to specific error information in the database that is being managed for each machine type.

Then, based on these various information which are sent from the user side to the service center 109, the server 105 judges whether or not to propose the optimum operation.

Note that, a format used for the information data sent from the host 101 to the server 105 of the service center 109 at step 8305, may be any type of format upon the transmission, provided that the software used by the host 101 and the software used by the server 105 are mutually analyzable. For example, the information may be sent by email in a text format, or in a format using an MIB, Internet facsimile (IFAX), job control language (JL), or other such formats, or it may be sent in an original language format or in a format that is a combination of these.

As a result of the diagnosis at the database 107, in a case where, the non-optimal operation result exceeds a certain threshold value even though a better operation method can be achieved by expanding optional apparatuses and the like, the optimal operation method is notified to the host 101 of the user to whom the proposal should be given (step 8308).

The user's host 101, having received the optimum operation method notification from the service center 109, analyzes the received content and automatically displays the proposed operation method on the display screen of the host 101 (step 8309).

Following this, a purchase request is received on the display screen of the host 101 (step 8310).

When the purchase request is sent by means of a button click at step 8310, the order content is sent to the server 105 of the service center 109 (step 8311).

The service center 109 confirms inventory information and the like and executes order processing for the received order (step 8312).

Further, when the ordering is complete, information including the content of the order, the due data of product deli very, a fee, and the like, is notified to the user (step S313).

In this way, according to the present invention, not only is the optimum operation proposed for the image forming apparatus (the printer 103) used on the user side, but also the server 105 can execute processing to receive the order from the user. Accordingly, the user can purchase, at the optimum timing, the image forming apparatus options and the like which the user needs, and can construct the image forming apparatus which is easy for the user to use.

[Example of DI Screen of Optimum Proposal]

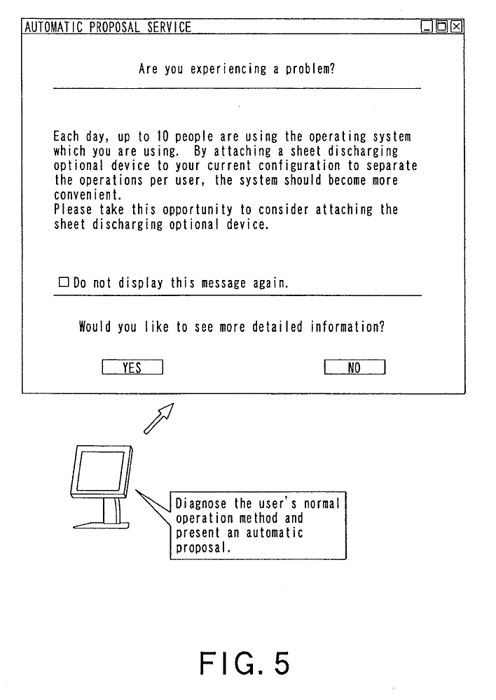

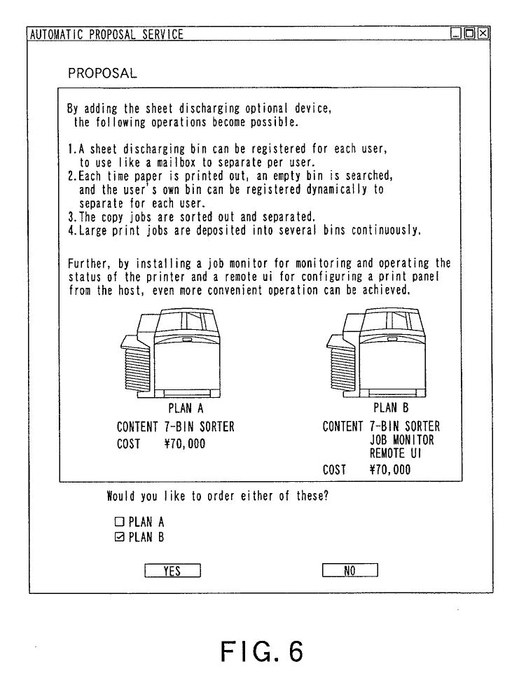

An example of an DI (user interface) screen shown in FIG. 5 and FIG. 6 is an example for proposing to add a sheet discharging optional device, to enable separation among a plurality of users.

In the UI screen for the optimum proposal in this embodiment, the proposal is divided into a plurality of windows. FIG. 5 is an introduction screen relating to adding the sheet discharging optional device, in which the general content of the proposal is displayed. In a case where the user sees the screen and is interested in the proposal, the screen changes to a subsequent screen showing more detailed information. Further, in the screen in FIG. 5, it is also possible to block the same proposal from being made repeatedly.

In FIG. 5, when the user shows interest and presses a “Yes” button, the screen changes to the detailed screen of FIG. 6. In the screen of FIG. 6, there is an explanation of the kind of operation which will become possible when the sheet discharging optional device is attached. Further, accompanied by this proposal, a proposal is also made for application software which enables printer status monitoring and operation of the printer from the host computer, thus offering the new proposal corresponding to the user's current operation. Further, purchase requests for optional devices needed for the above-mentioned proposal can also be made on the same screen, thereby eliminating ordering by telephone, sending a FAX and other such user tasks relating to adding the optional device.

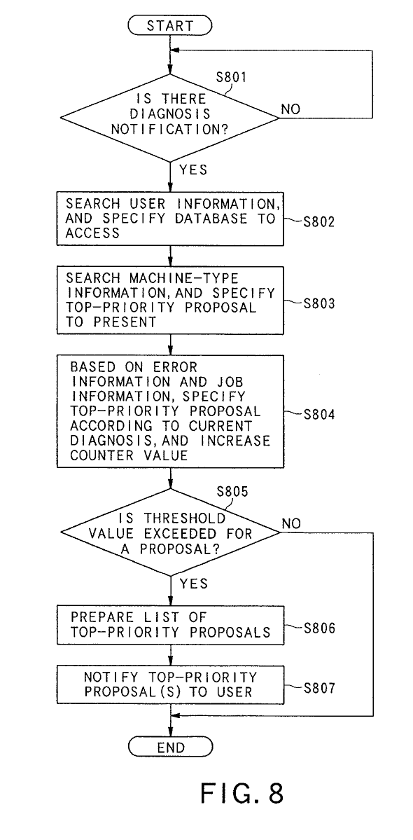

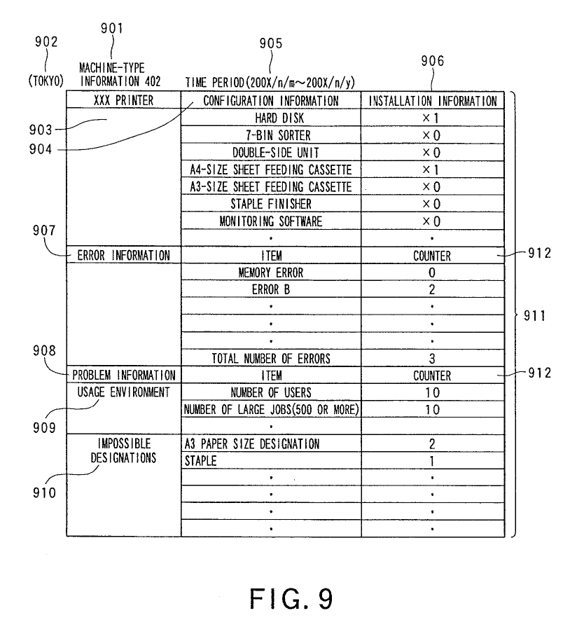

Note that, the operation diagnosis processing including proposal search processing in FIG. 5 and FIG. 6 conducted on the service center 109 side, is explained in detail below using FIG. 8 and FIG. 9.

Further, the optimum proposal in this embodiment, is not limited to the example above, but rather can be adapted to any type of proposal.

[Proposal Examples]

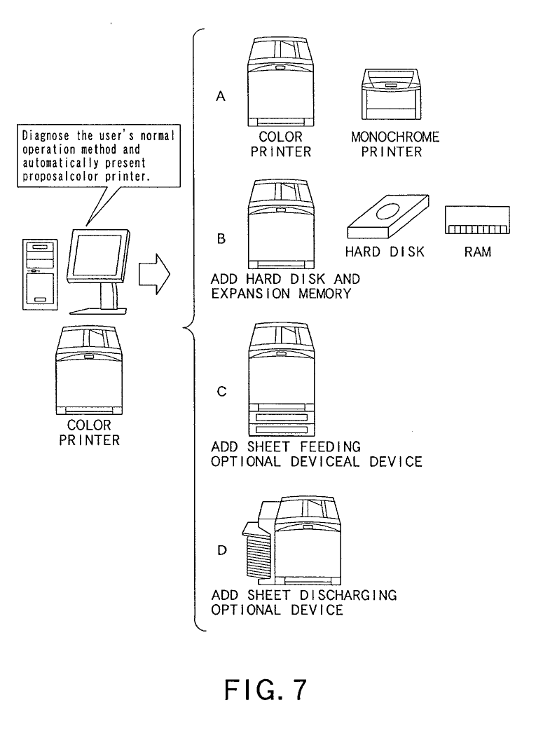

FIG. 7 is a diagram showing proposal examples for optimum operation of a color printer using the operation management system in FIG. 1.

FIG. 7 shows an example in which the user is operating a standard-equipment color printer. Depending on differences in the operation method of the color printer, four proposal examples A, B, C and D are given below.

The first example is an example in which monochrome word-processing text printing, and color data printing such as image data and tables/graphs, are frequently performed in a mixed manner. For example, as shown by proposal A, the monochrome printer addition is recommended, and the color printer and the monochrome printer can be installed in line, thus separating color printing and monochrome printing per printer.

Further, in the operation by the user, in a case where a large amount of data for which a designation for multiple copies is made exists, or in a case where a large proportion of data is heavy to process and internal processing takes a long time due to memory shortage with a high frequency, or in a case where the same data from the host computer is repeatedly printed a number of times, a proposal can be made such as in proposal B, to add the hard disk and expanded memory, and enable RIP-Once processing (multiple copies from 1 translation) and Transmit-Once processing (multiple copies from 1 data transmission) in which the data is spooled inside the printer and can be reused multiple times, and transitions to compression processing triggered by the memory shortages are suppressed to make the proposal to achieve high-speed operations.

Further, in a case of frequent operator calls indicating that there is no paper or requesting to change the sheets, a proposal such as proposal C can be made to promote the addition of a sheet feeding optional device to increase the ability to feed the paper.

Further, in a case where overload occurs frequently, or many people share and use the printer, or in a case where multiple printer copies are frequently designated, a proposal such as proposal D can be made to promote the addition of the sheet discharging optional device, and to increase the sheet discharging capacity, and create an environment in which divisions by means of user separation and sorting and the like are possible, to thus increase usability.

The above-mentioned examples are examples relating to the optional device expansion, and the proposal examples are not limited to the above-mentioned A, B, C and D. Rather, a proposal combining the above-mentioned A, B, C and D may be made, and it goes without saying that still different proposals may be made.

[Operation Diagnosis Processing]

Next, using FIG. 8, explanation is given regarding processing for diagnosing the operation of the server 105, at the service center 109.

First, the stand-by state continues until the operation information is sent from the user to the service center 109. When the data of the forwarded information 400 such as shown in FIG. 4 is sent, the processing advances to step 8802 (step 8801).

Next, the user information 401 in the forwarded information 400 data is searched, and the object database is specified (step S802).

Next, a top-priority proposal for the current state of the user's device configuration is picked up based on the machine-type information 402 (step 8803). Here, the top-priority proposal includes the operation proposal for the color printer, which is specified according to the forwarded information 400, and which will make the device easy to use.

Further, based on the error information 403 and the job information 404, which are the main information in the problem information, the top-priority proposal matching this information is specified, and an operation of counting up the matching top-priority proposals is performed (step 8804).

Through the counting-up, judgment is made as to whether or not a counter has exceeded a given threshold (step S805). In a case where the counter has not exceeded the given threshold, the processing ends at this point.

Then, in a case where the counter has exceeded the given threshold, it is understood that much user's inconvenience is occurring. Therefore, a list of top-priority proposals is prepared (step S806).

The list thus prepared is used to perform the top-priority proposal for the user (step S807).

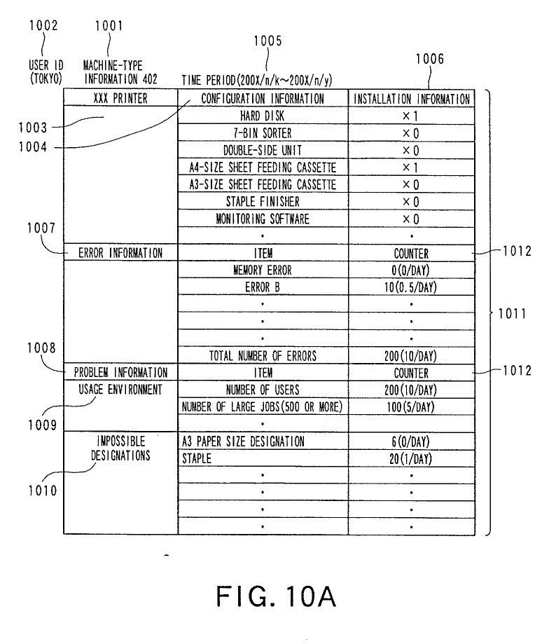

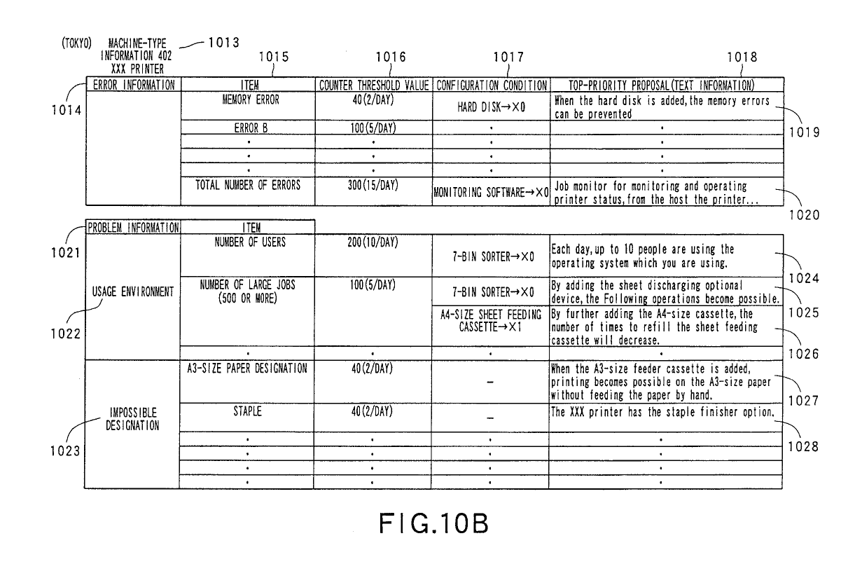

Here, making reference to FIG. 9 and FIGS. 10A and 10B, the flowchart in FIG. 8 is used to give a detailed explanation of processing in which:

a database for storing the optimum operation proposal for the image forming apparatus is provided to the information processing apparatus (the server 105) which can connect to the user apparatus (the host computer) via the communications medium and perform the operation management processing; and

the image forming apparatus problem information notified from the user apparatus is received, and based on the received problem information, the image forming apparatus optimum operation proposal which is extracted from the database is presented.

First, FIG. 9 shows details of the forwarded information 400 notified from the server 105 at the service center 109 at step S801.

Reference numeral 903 corresponds to a product ID in the machine-type information 402 in FIG. 4. At step S802, based on the machine-type information 402 (901) and the user information 902 included in the forwarded information 400, the information which should be accessed in the database is specified.

Then, at step S803, the top-priority proposal for the user's current device configuration is picked up. When this occurs, the server 105 references the database such as shown in FIGS. 10A and 10B. The database in FIGS. 10A and 10B corresponds to the database 107 in FIG. 1.

Reference numeral 905 shown in FIG. 9 indicates a time period corresponding to the forwarded information 400. In FIG. 9, the time period is represented as “200X/n/m-200X/n/y”. The span of the time period depends on the timing of the notification of the forwarded information 400 from the user side.

Reference numeral 904 is configuration information regarding “XXX printer” indicated by reference numeral 903. Installation information 906 indicates installation status corresponding to the configuration information 904. In the diagram, “x1” means that one is installed. “x0” means that none are installed. Further, the configuration information 904 is continuously updated in the database 107 by obtaining the latest information by connecting online, and the latest status is saved per user and per machine type. Therefore, no matter when the forwarded information 400 is sent, the proposal can always be made with the latest configuration information 904.

Further, the server 105 is provided with updating means for updating the configuration information of each machine, when a new option is sold to each type of image forming apparatus. Then, in a case where new configuration information is added to the database 107 by means of the updating means, the optimum operation can be presented, based on the already accumulated problem information from the printer on the user side and the updated configuration information.

For example, when the user purchased the image forming apparatus, even in a case where a “7-bin sorter” sheet discharging optional device has not been sold yet, when it is sold, if the user's image forming apparatus's previously accumulated problem information (the counter value) satisfies conditions indicating that the “7-bin sorter” should be purchased, the optimum operation can be presented.

The error information 907 includes a plurality of types of items. The diagram shows a “memory error”, an “error B” and a “total number of errors”. Note that, the total number of errors is a total sum of the number of times that error in each item has occurred.

This information is based on information recognized detection means and error recognition means provided inside the printer and inside the host computer. The detection means and the recognition means may be sensors provided to the printer, or may be programs in the host computers for judging errors based on the notification information from the printer, or may be programs in the host computers for recognizing mismatches between printer settings set when the user generated the printer data, and the printer's configuration information.

The problem information 908 corresponds to an item for managing the problem info that is included in the machine-type information 403, the job information 404, etc. in FIG. 4. In FIG. 9, as the problem, detailed items regarding the “usage environment” are shown in a usage environment item 909, and detailed items regarding “impossible designation” are shown in an impossible designation item 910. The items in the error information 403 in FIG. 4 may be included in the problem items as needed.

Further, specifically, the detailed items relating to the usage environment item 909 include “number of users” and “number of large jobs”. The “number of users” item indicates the number of users who have used the color printer, and this number is obtained by recording the number of user identifiers which have been applied to the jobs in the color printer. The “number of large jobs” item is obtained based on the number of jobs exceeding, for example, 500 pages printed by the color printer.

The impossible designation 910 information is explained in detail in Embodiment 2. However, in FIG. 9, “A3-size paper designation” and “staple” are shown as the detailed items under the impossible designation item. Both of these designations are obtained based on the color printer printing the designations which are impossible to each item being designated to the color printer.

Reference numeral 912 indicates counters, which indicate counter values for each detailed item of the error information 907 and the job information 908. Further, if the time period 905 is set to one day, and the forwarded information 400 from the user side is notified to the server 105, the counter values of the counters 912 for each item indicate the number of events occurring daily.

Note that, the forwarded information 400 shown in FIG. 9 only pertains to the “XXX printer”. However, in a case where a plurality of types of image forming apparatus are being used on the user side, the forwarded information 400 for each machine-type is notified to the server 105.

FIGS. 10A and 10B illustrate information that is accumulated and saved in the database 107 used by the server 105. FIGS. 10A and 10B show information for referencing the configuration information and the like of the color printer and based on the information, the optional proposal is made.

The information in FIG. 10A is updated per user 1002 and per machine-type information 402 (1001), based on the forwarded information 400 shown in FIG. 9. Namely, in the database 107, the error information 907 and the problem information 908 are registered and their history is managed per device. Accordingly, when the forwarded information 400 is transmitted, the optimum proposals are made for each device. The updating which takes place here corresponds to the processing in the above-mentioned steps S801, S803 and S804.

The user ID 1002 shows information for discriminating specified users based on the user information 402.

The installation information 1006 and the information of each item in a counter 1012 are prepared based on counter installation information 906 and the information 911 in each of the items of the counters 912, which are shown in FIG. 9 (this corresponds to step S804).

FIG. 10B shows information for searching for the top-priority proposal corresponding to the configuration conditions specified in the machine-type information 402. This information corresponds to the information held in the database 107.

Each item indicated by reference numerals 1003, 1004, and 1007 through 1010 corresponds to each item indicated by reference numerals 903, 904, and 907 through 910 in FIG. 9, which were explained above. Therefore, detailed explanations thereof are omitted.

Reference numeral 1005 indicates a time duration during which the accumulated data in FIG. 10A corresponds to.

The installation information 1006 corresponds to the installation information 906 explained in FIG. 9. Namely, if the installation information 906 in the forwarded information 400 has been updated, the installation information 1006 is also updated in synchronization.

A management value 1011 corresponding to the counter 1012 is updated at any time based on the forwarded information 400 in FIG. 9. In the management value 1011 corresponding to the counter 1012, a “accumulated value” and an “daily average value” for a given time duration are managed. The server 105 is provided with counter accumulation means, and calculating means for calculating the counter average per given time duration.

The management value 1011 corresponding to the counter 1012 is used when referencing the table for searching for the top-priority proposal in FIG. 10B described below.

FIG. 10B shows a table for specifying a correspondence relationship between the top-priority proposal and the management value 1011 of the counter 1012 and corresponds to a table specified based on the “XXX printer” information in the machine-type information 402 (1013). In other words, the table corresponding to each machine type in FIG. 10B is held in such a way that it can be searched by the database 107.

The items corresponding to each of the reference numerals 1014 and 1021 through 1023 correspond to the reference numerals 907 and 908 through 910 explained in FIG. 9, and thus correspond to reference numerals 1007 and 1008 through 1010, respectively, which were explained in FIG. 10A.

Each of the detailed items indicated by reference numeral 1015 correspond to each detailed item included in the error information 907 and 1007, and the problem information 908 and 1008 in FIG. 9 and FIG. 10A. Therefore, detailed explanations thereof are omitted.

The counter threshold value 1016 and the configuration conditions 1017 corresponds to judgment values for judging whether or not to present the top-priority proposal to the user. In other words, the image forming apparatus configuration information which was specified based on the information specifying the image forming apparatus included in the forwarded information 400 is referenced, and the presentation of the optimum operation based on the referenced configuration information and the problem information (the counter value) is executed based on the database in FIG. 10B. Note that, the judgment of whether or not the counter threshold value 1016 condition is satisfied is performed based on the values in each of the items of the counter 1012. Further, the judgment of whether or not the configuration condition 1017 is satisfied, is performed based on the configuration information 1004 and reference of each of the items of the corresponding installation information 1006.

For example, regarding the counter value 1012 of the number of users who used the system, which is managed in FIG. 10A, the accumulated value 200 and the daily average are 10, and the configuration information 1004 indicates that the 7-bin sorter is not installed. Therefore, both the counter threshold value 1016 and the configuration condition 1017 are satisfied (this corresponds to Yes at step 8805), and a corresponding message of reference numeral 1024 is extracted as the top-priority proposal, and this is informed to the user (this corresponds to step S807). Note that the top-priority proposal 1024 corresponds to the proposal content in FIG. 5. Further, the top-priority proposals 1025 and 1020 arranged correspond to the proposal content in FIG. 6.

Further, the server 105 and the database 107 coordinate with each other, whereby the types of problem information combined with particular configuration information are varied, which enables different optimum operations to be presented. In other words, even when the configuration condition 1017 is the same, the type of the problem information is different, whereby the different optimum top-priority proposal can be presented to the user, for example as shown by reference numeral 1024 to reference numeral 1028 in FIG. 10B.

Note that the judgment of whether or not the counter 1012 value satisfies the counter threshold value 1016 condition may be performed based on only one of the “accumulated value” and the “daily average value”, or judgment as to whether or not both the conditions are satisfied may be performed.

Further, in response to information about the user's intention information, setting means for adopting a counter threshold value (condition) which is different from normal may be provided to a predetermined type of image forming apparatus. An item containing the user intention information is included in the UI screen of FIG. 11 described below, and the counter threshold value is set based on the intention information which is notified to the server 105 via the UI screen of FIG. 11. For example, a complaint such as “I need the printer output for work”, or “Occurrence of the printer error is extremely problematic” or the like is included in the user intention item, and in the case where the intention information is notified to the server 105, the setting means of server 105 sets the counter threshold value lower than normal, so that the optimum operation is presented at an earlier timing than normal. Further, the user intention information may also be included in the usage environment item or an operation objective item in FIG. 4.

In this way, according to the construction described in FIG. 9 and FIGS. 10A and 10B, the error information 907 and 1007, and problem information 908 and 1008 containing the impossible designation 910 and 110 introduced from the forwarded information 400 serving as the problem information notified from the user side, are used to present the optimum operation proposal for the color printer being used by the server 105.

Note that, in accordance with this embodiment explained above, there is one server 105 at the service center 109. However, it goes without saying that there can be a plurality of the servers 105, and they can be configured to perform parallel processing which is different per product and per geographical area, etc. Further, the configuration in FIG. 10A and FIG. 10B may be constructed to propose the optimum operation in FIG. 7 which is explained above. In other words, as an example of an application, the item types indicated by reference numerals 1004, 1007 and 1008 included in the forwarded information 400 in FIG. 10A, and the conditions in each item indicated by reference numerals 1016, 1017 and 1018 in FIG. 10B, may be included in the database 107 as appropriate.

[Registration Processing]

Next, FIG. 11 shows an example of the UI screen for performing a user registration, in order to perform the automatic proposal.

FIG. 11 shows an example of registering the user information 401 and the machine-type information 402 which are in the forwarded information 400 shown in FIG. 4. The user information 1101 which is registered in FIG. 11 is information which the server 105 at the service center 109 uses to judge a destination it should reply to in the case where it receives the diagnosis notification, and to judge a location to which a serviceman should be sent. The machine-type information 1102 registered in FIG. 11 is information indicating which portion of the database 107 should be accessed, and for narrowing down a situation which caused trouble to occur, to perform as fast and accurate a diagnosis as possible.

Further, in FIG. 11, columns for inputting the “usage environment”, the “operation objective” and a “purchase date” are not shown. However, input columns may be created as appropriate, and at the user registration time, they may be stored into the database 107 at the service center 109 in an accessible manner. Further, as described above, in the case where the user intention information is included in the items such as the usage environment and the operation objective, the user intention information is used by the server 105 when setting the counter threshold value. Note that the setting of the threshold value may be automatically performed by the server 105, or may be set in response to an operation instruction from an operator.

The information may be managed at the service center 109, or may be managed by an application running on the host 101 such that it is always sent at the time when the operation information 400 is sent.

When the trouble occurs as described above, the trouble content is notified to the service center 109 via the Internet 108, and at the service center 109 the top-priority proposal is searched for based on the machine-type information 402, the error information 403 and the job information 404 in FIG. 4. The reply is made based on the user information 401 to show the new proposal to the user and transmit that there is a more convenient operation method, whereby the trouble can be resolved without the user bothering with the telephone or the FAX.

Further, the operation information occurring at the user side can be automatically learned at the service center 109. Therefore, the operation method being used by the user can be learned easily, and a quick response can be made to the user's needs.

### Embodiment 2

In accordance with Embodiment 1 described above, explanation was given regarding the example in which, among the problem, the occurrence of the error served as a trigger. However, the judgment criterion is not limited only to the errors displayed on each user apparatus. For example, in a case where the impossible designation is made to approximate into an internally executable designation, or in a case of not being an error but where an operation exists which can improve the acceleration or the convenience of finishing processing or the like, this can serve as the trigger, to notify the problem information to the service center and perform the diagnosis of the user's operation.

Note that, in accordance with this embodiment described below, the same reference numerals are applied to aspects explained in the previous embodiment to abbreviate, and detailed description is given regarding characteristics of this embodiment.

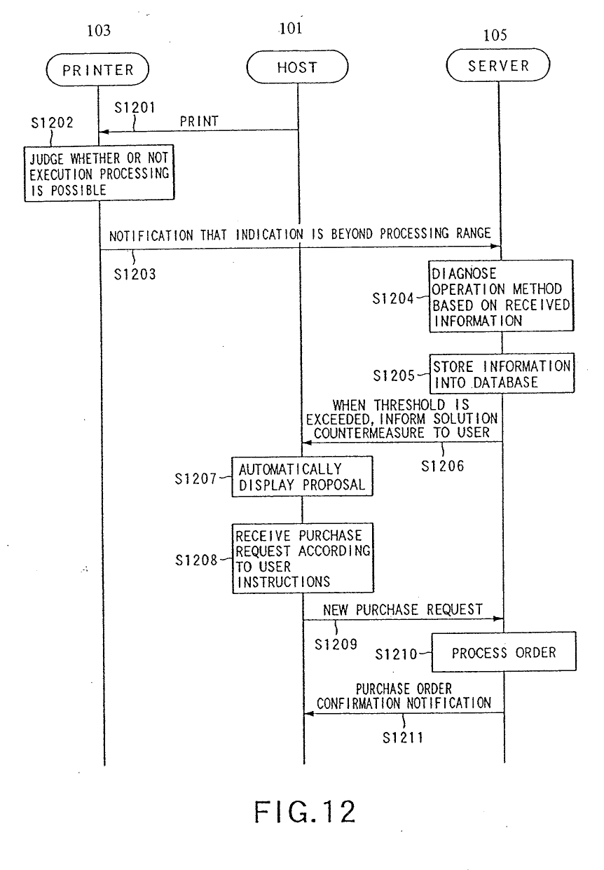

FIG. 12 is used to explain Embodiment 2.

For example in a case where a designation to staple is given to a printer having an apparatus construction which is incapable of stapling, there are cases where the designation to staple is ignored and the printing is simply performs. Even in a case such as this, it is judged that the impossible designation has been received, and the operation information is notified via the hosts 101 and 102 or directly to the service center 109. The server 105 at the service center 109 which received the notification performs the diagnosis and the threshold value judgment similarly to the case of Embodiment 1, and the optimum operation method is proposed to the user at the necessary timing.

In other words, first, the user gives the print instruction from the host 101, and sends the data to the printer 103 (step S1201).

At this time, for example, when the printing is executed a judgment is made whether or not the printer 103 can print it (step S1202).

Then, in a case where the print instruction is beyond the processable scope, the printer—103 directly notifies the server 105 that the print instruction is beyond the processable scope (step S1203).

Note that, it goes without saying that an embodiment can be used in which the problem information notification, including the notification that the print instruction is beyond the processable scope, is notified from the image forming apparatus (the printer) to the server 105 via the host computer, as explained at steps 8303 and 8305 in Embodiment 1.

Next, the server 105 at the service center 109 which has received the unprocessable print processing notification, diagnoses the user's operation method based on the received information (Step S1204).

Then, database information of the given user is updated based on the diagnosis (Step S1205).

Here, forwarded information 400 sent from the user side to the service center 109, includes as shown in FIG. 4, for example, user information 401, machine-type information 402, error information 403, and job information 404.

The user information 401 is used mainly used as a link to 32 the user information in the database 107, and as information on a return address to which the diagnosis results are sent. The machine-type information 402 is used as material for diagnosing whether or not the operation is optimal, based on the received operation information. Further, the error information 403 and the job information 404 are used as information for accessing a database relating to specific error information in the database that is being managed for each machine type.

Then, based on these various information which are sent from the user side to the service center 109, the server 105 judges whether or not to propose the optimum operation.

Note that, a format used for the information sent from the host 101 to the service center 109 at step S1203, may be any type of format, provided that the software used by the host 101 and the software used by the server 105 are mutually readable. For example, the information may be sent by email in a text format, or as an MIB, or Internet facsimile (IFAX) or in job control language (JL) , or other such format, or it may be sent in an original language or in a format that is a combination of these.

As a result of the diagnosis at the database 107, in a case where, the non-optimal operation exceeds a particular threshold value even though a better operation method can be achieved by expanding optional apparatuses and the like, the optimal operation method is notified to the host 101 of the user to whom the proposal should be given (Step S1206).

The user's host 101, having received the optimum operation method notification from the service center 109, analyzes the received content and automatically displays the proposed operation method on the host 101 display screen (Step S1207).

Then, a purchase request is received on the host 101 display screen (step S1208).

When the purchase request is sent by means of a button click at step S1208, the order content is sent to the server 105 of the service center 109 (step S1209).

The service center 109 confirms inventory information and the like and executes order processing for the received order (step S1210).

Further, when the ordering is complete, information including the order content of the order, a planned product delivery date, a monetary fee, and the like, is notified to the user (step S1211).

Not only with respect to the above-mentioned error occurrence, but also for the impossible designation job and other normal jobs, it is diagnosed whether or not a further top-priority proposal is possible. Accordingly, the diagnosable scope can be widened.

### Embodiment 3

In accordance with the above-mentioned Embodiment 1 and Embodiment 2, explanation was given regarding the operation management system up to the optimum proposal to the user, in the system using the color printer. However, the present invention is not limited to the above-mentioned example.

Below, explanation is given regarding an operation management system according to Embodiment 3, in which the host computer used in Embodiment 1 is not used, and a copying machine and a facsimile machine (a FAX) and the like serve as the host computer, and the user apparatus and the image forming apparatus (the apparatus being used) are the one same apparatus.

Note that, the copying machine and the facsimile machine (the FAX) and the like according to Embodiment 3 basically have the functions as the image forming apparatus (the printers) and the host computers explained in Embodiments 1 and 2.

Note that, in accordance with this embodiment below, the same reference numerals are applied to aspects explained in the previous embodiments to abbreviate, and detailed description is given regarding characteristics of this embodiment.

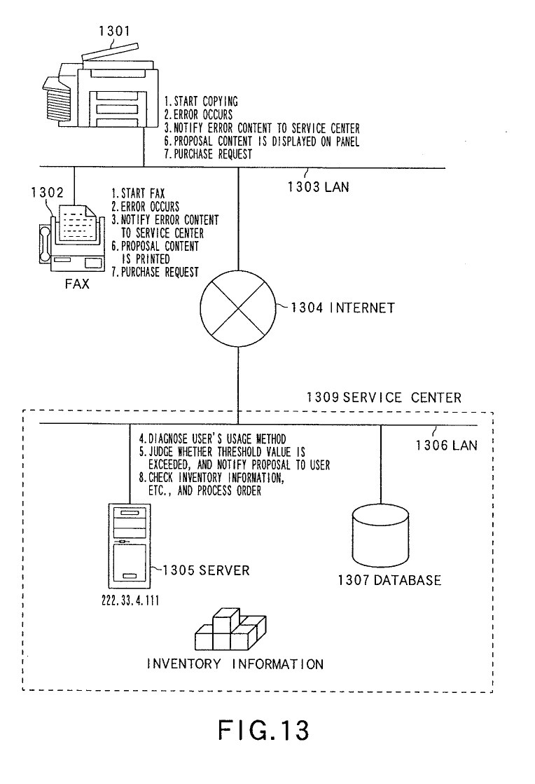

FIG. 13 is a diagram for showing one example of the optimum operation management system using a copying machine 1301 and a facsimile machine (FAX) 1302, according to Embodiment 3 of the present invention. FIG. 13 shows concepts of processing from presenting the optimum operation to order completion of a new order.

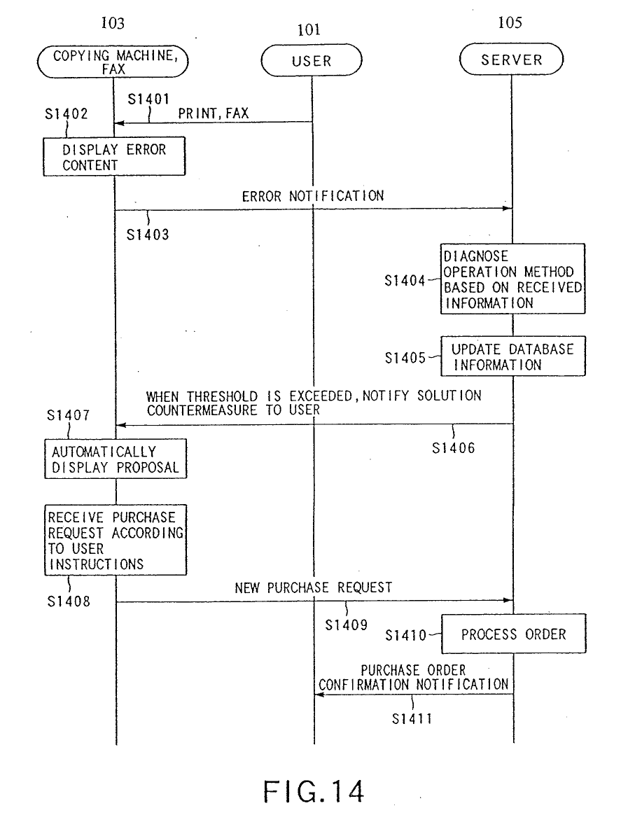

Further, FIG. 14 is an event tracing diagram for explaining a flow, using the operation management system in FIG. 13 according to Embodiment 3, from an occurrence of trouble in the copying machine 1301 or the facsimile machine (FAX) 1302, until the automatic proposal regarding the optimum operation.

[Construction of the Operation Management System]

First, explanation is given regarding a system construction according to Embodiment 3 with reference to FIG. 13. In FIG. 13, a copying machine 1301 serving as a user apparatus having an Internet protocol (IP) address “111.2.33.44” and a facsimile machine (FAX) 1302 serving as a user apparatus having an IP address “111.2.33.55” are configured on the same LAN 1303.

Further, a server 1305 serving as an operation management server having an IP address “222.33.4.111” is configured on a LAN 1306 of a service center 1309.

Further, each of LANs 1303 and 1306 is connected via the Internet 1304.

[Operation Management Procedure]

Explanation will be given regarding procedures of the operation management in a case where the trouble has occurred when the user is making a copy, or the operation management in a case where the trouble has occurred when the user is sending or receiving a facsimile, according to the system of Embodiment 3 having the above-mentioned construction.

The operation management according to Embodiment 3 shown in FIG. 14 is basically substantially similar to the operation management system of Embodiment 1 shown in FIG. 3. However, the operation management of Embodiment 3 can operate without going through the host computer. Therefore, all the processing performed on the host computer in Embodiment 1 is performed by the copying machine 1301 and the facsimile machine (FAX) 1302 themselves.

For example, the error display is performed on a display panel of the copying machine 1301, the facsimile machine (FAX) 1302 or the like, and the notification of the operation information to the service center 1309 is also performed by the copying machine 1301 or the facsimile machine (FAX) 1302.

This point is different from Embodiment 3 and Embodiment 1.

First, the user, for example, gives a copy instruction for the copying machine 1301, or instructs a facsimile transmission by the facsimile machine (FAX) 1302 (step S1401).

When this is performed, in a case where the error or other such trouble has occurred at the copying machine 1301 or the facsimile machine (FAX) 1302 and the copying or the facsimile transmission cannot be performed, the error content is displayed on the display panel of the copying machine 1301 or the facsimile machine (FAX) 1302 so that the user can easily understand it (step S1402).

The processing up to this point is processing that is generally performed even with the conventional copying machine and facsimile machine (FAX). The characteristic of this embodiment is the processing described after step S1403. By performing the processing after step S1403, the operation methods used by many users and their problems can be learned as much as possible, and based on this information the operation methods used by the users are diagnosed and proposals for optimum operations are automatically proposed. Also, by enabling the purchase request to realize the optimum operation to be made via the Internet, the convenience for the user is increased.

Next, the copying machine 1301 or the facsimile machine (FAX) 1302 directly performs the trouble notification to the server 1305 at the service center 1309 (step S1403).

Next, the server 1305 at the service center 1309 which has received the error notification diagnoses the operation method used by that user, based on the received information (step S1404).

Then, database information of the given user is updated based on the diagnosis (step S1405).

Here, forwarded information 400 sent from the user side to the service center 1309, includes as shown in FIG. 4, for example, user information 401, machine-type information 402, error information 403, and job information 404.

The user information 401 is used mainly used as a link to the user information in the database 1307, and as a information on return address to which the diagnosis are sent results. The machine-type information 402 is used as material for diagnosing whether or not the operation is optimal, based on the received operation information. Further, the error information 403 and the job information 404 are used as information for accessing a database 1307 relating to specific error information in the database that is being managed for each machine type.

Then, based on these various information which are sent from the user side to the service center 1309, the server 1305 judges whether or not to propose the optimum operation.

As a result of the diagnosis at the database 1307, in a case where, the non-optimal operation exceeds a particular threshold value even though a better operation method can be achieved by expanding optional apparatuses and the like, the optimal operation method is notified to the copying machine 1301 (or a facsimile machine (FAX) 1302) of the user to whom the proposal should be given (step S1406).

The copying machine 1301 or the facsimile machine (FAX) 1302, having received the optimum operation method notification from the service center 1309, analyzes the received content and automatically displays the proposed operation method on the copying machine 1301 display screen or the facsimile machine (FAX) 1302 display screen (step S1407).

Then, a purchase request is further received (step S1408).

When the purchase request is sent by means of a button click at step S1408, the order content is sent to the service center 1309 (step S1409).

The service center 1309 confirms inventory information and the like and executes order processing for the received order (step S1410).

Further, when the ordering is complete, information including the order content of the order, a planned product delivery date, a monetary fee, and the like, is notified to the user (step S1411).

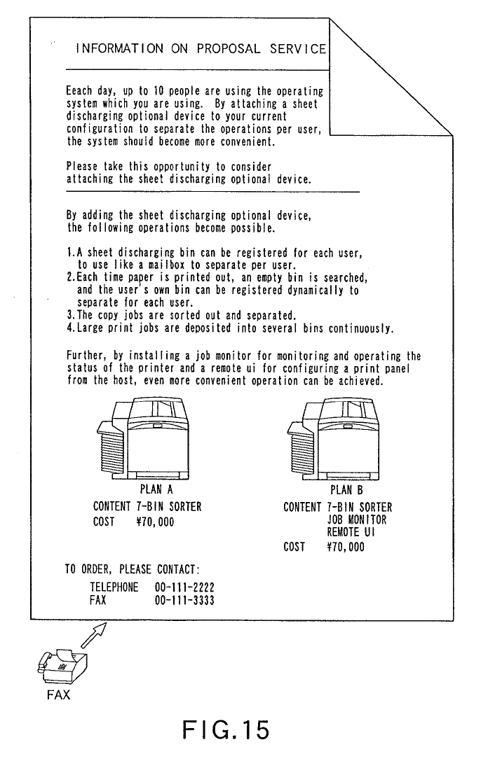

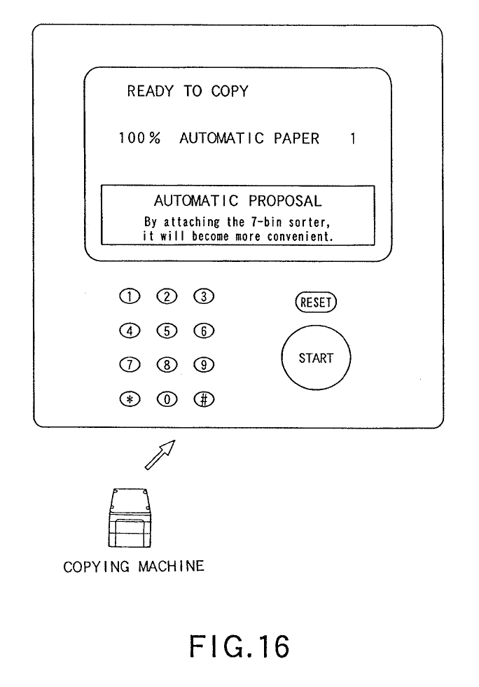

The proposal examples shown in FIG. 15 and FIG. 16 are examples which propose adding the sheet discharging optional device to enable separation among the plurality of users. FIG. 15 shows an example printed by the FAX, and FIG. 16 shows an example on the operation panel of the copying machine.

In these proposals, explanations are given regarding what further kind of operation is possible in the case where the sheet discharging optional device is attached. Further, a proposal is also given regarding application software for enabling monitoring the copying machine and the FAX status, and also enabling the copying machine and the FAX to be operated from the computer, and a new proposal tailored to the user's current operation is given.

Further, since the purchase request for the options necessary for the above-mentioned proposal is possible on the same screen, the user's effort to order by phone and send a FAX and the like to add the option can be eliminated.

### Embodiment 4

In accordance with the above-mentioned embodiment, examples were shown regarding the operation management in the network-connected apparatus. However, the present invention is not limited to the above-mentioned examples. For example, it can also be applied in a system using only an apparatus to which an I/O device is directly connected without going through a network, such as a system constructed only with a host computer and a printer (i.e., the system of Embodiment 4). Note that, the image forming apparatus and the printer in Embodiment 4 are provided with the functions other than the functions relating to the purchase, which were described in Embodiment 1 through Embodiment 3.

Embodiment 4 is a system for executing the operation management without using the service center server such as one explained in Embodiment 1. In the operation management in Embodiment 4, the purchase request cannot be made for the option that was proposed as in Embodiment 1, but the execution is possible up to the automatic proposal for the optimum operation.

In accordance with Embodiment 4, the information relating to the operation management and the diagnosis program are stored in an application program for the host computer, for example, or in the image forming apparatus. As a result of the diagnosis, in a case where it is judged that better proposal than the current operation is possible, the information stored in the above-mentioned host computer or the image forming apparatus is searched, and the necessary information is obtained by a similar procedure to the procedure explained in Embodiment 1, whereby the optimum method can be notified to the user by means of a display, printing, audio, or the like.

### Embodiment 5

In accordance with the above-mentioned embodiments, explanation was given regarding the operation management systems used in the network-connected apparatus. In accordance with Embodiment 5, explanation is given regarding an operation management system used in an apparatus which is not connected to a network, such as a digital camera.

[Construction of the Operation Management System]

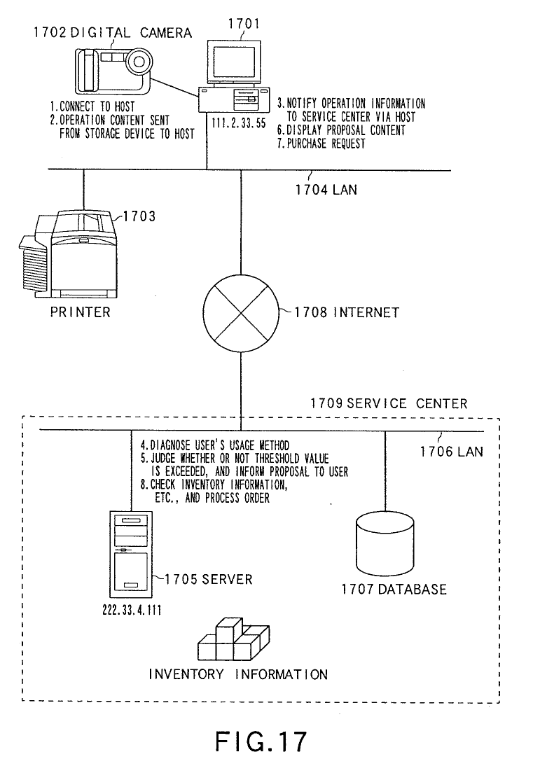

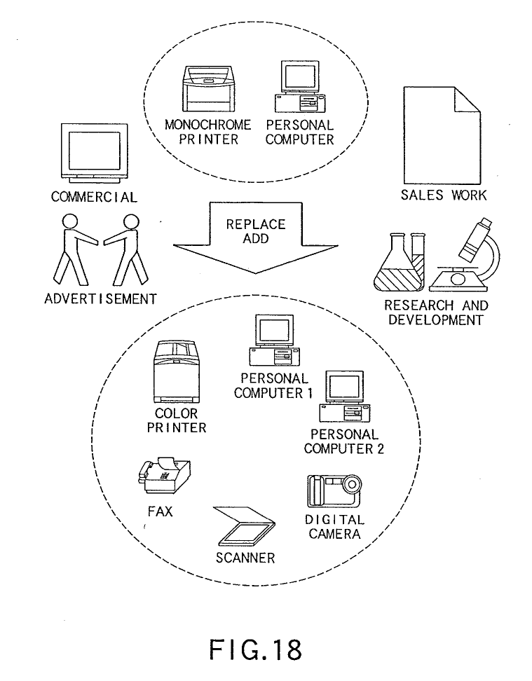

FIG. 17 is a conceptual view of one example of a system for proposing an optimum operation for a digital camera 1702 according to Embodiment 5 of the present invention, and shows processing up to an automatic proposal.

Explanation is given regarding a system construction according to Embodiment 5 with reference to FIG. 17. In Embodiment 5, a host 1701 serving as a user apparatus which is a computer having an Internet protocol (IP) address “111.2.33.44” and a printer 1703 having an IP address “111.2.33.55” are configured on the same LAN 1704.

Further, a server 1705 serving as an operation management server having an IP address “222.33.4.111” is configured on a LAN 1706 of a service center 1709.

Further, each of LANs 1704 and 1706 is connected via the Internet 1708.

[Procedure of the Operation Management Procedure]

Explanation is given regarding procedure of processing in a case where the trouble has occurred when the user is using a non-network produce, according to Embodiment 5 of the system construction mentioned above.

At the time when the trouble occurs in the non-network product such as a digital camera 1702, the trouble content and the operation method are saved in a memory or other such storage section of the apparatus.

Then, when connecting to the host computer for data downloading, processing, or the like, the digital camera 1702 is connected to the network product such as the personal computer represented by the host 1701 or the printer 1703 shown in FIG. 17, or the copying machine (not shown in the diagram). In a case where there exists operation information that is saved when the trouble has occurred, the connection to the network product triggers the notification to the service center 1709. Thus, the automatic notification becomes possible.

Note that, other content of Embodiment 5 is the same as the content explained in the previous embodiments. Therefore, explanations regarding the method of operation management is abbreviated.

### Embodiment 6

In accordance with the above-mentioned embodiments, the explanations were given regarding the operation management systems used with the printer, the copying machine, the facsimile machine (FAX), and other such output Apparatuses, mainly business machines.

However, the above-mentioned operation management system is not limited to business machines. For example, it may be an operation management system used in the apparatuses being used such as a television, a personal computer, a microwave oven, a refrigerator, a laundry machine, an air conditioner, a component stereo system, an electronic piano, a game machine, or other such household electrical appliances.

Further, the above-mentioned operation management system may be an operation management system for performing the top-priority proposal regarding application software operating on the personal computer, or on the game machine, or the like.

Now, explanation is given below regarding the operation management system used in the household electrical appliance such as described above, as Embodiment 6.

Instead of connecting the operation management system according to Embodiment 6 to the printer 103 shown in FIG. 1 and FIG. 3 of Embodiment 1, it is connected to one of household electrical appliances such as the above-mentioned television, the personal computer, the microwave oven, the refrigerator, the laundry machine, the air conditioner, the component stereo system, the electronic piano, and the game machine.

Therefore, the method of processing the trouble in the operation management system according to Embodiment 6 is the same as the content explained in FIG. 1 and FIG. 3 of Embodiment 1, for example.

Note that, since the explanations of the operation management system and the top-priority proposal method in Embodiment 6 are the same, the explanations are abbreviated here.

### Embodiment 7

In accordance with the operation management system of the above-mentioned embodiments, explanation was given regarding examples in which the operation information was notified to the service center upon each error occurrence, and each time the printing was performed, at each type of apparatus, and the operation method was diagnosed in real time.

However, the present invention is not limited to the above-mentioned embodiments, but can be applied also in a system in which the trouble processing is not performed in real time.

Below, explanation is given regarding a system according to Embodiment 7 in accordance with the present invention, for performing the trouble processing not in real time.

The operation management system of Embodiment 7 has the same construction as Embodiment 1 shown in FIG. 1, for example. However, the difference between Embodiment 7 and Embodiment 1 that the diagnosis of the operation is not performed in real time as in Embodiment 1. For example, the individual errors occurring in the printer and the jobs are not dealt with in real time. The number of individual error occurrences and the number of print jobs are counted in advance on the user apparatus or on the host computer or the like, and in a case where the number of occurrences exceeds a given number of times, the top-priority proposal explained in Embodiment 1 using FIG. 1 and FIG. 3 is performed.

Note that, other than the above-mentioned difference, there are not differences between Embodiment 7 and Embodiments 1 through 6.

Note that, since the explanation of the operation management system according to Embodiment 7 overlaps with the explanation of Embodiment 1, the explanation is abbreviated here.

In accordance with the above-mentioned embodiment, explanation was given regarding the example in which the trouble occurrence times were counted in advance an the host computer or the like. However, the trouble occurrence times and the number of print jobs can be saved as log information on the storage devices of the printer, the copying machine and the facsimile machine (FAX), and the diagnosis may be performed at timing freely chosen by the user by designating a panel, by pressing a button from the application program on the host computer or by another such simple operation.

As explained above, in accordance with the operation management system of the above-mentioned embodiment, the information relating to the user's operation method is automatically notified to the service center and the content of the operation method is diagnosed, whereby the optimum proposal can be made for the operation by the user.

Further, by automating the above-mentioned diagnosis, the optimum processing method can be notified to the user 24-hours a day, and quickly.

Further, by enabling immediate reception of the purchase request for the above-mentioned proposal, the time required to fundamentally fix the user's problem is drastically reduced.

Further, the operation method used by the user can also be learned easily, and in order to raise the user's satisfaction level, not only productivity adjustments and price adjustments, but also directions in which product development should progress can be discovered more quickly.

### Embodiment 8

In accordance with Embodiment 1 through Embodiment 7, explanations were given regarding embodiments in which the information of the product which should be purchased was sent as the optimum operation information to the device on the user side. However, the present invention is not restricted only to this, but rather, it can also be applied in an embodiment for presenting information about unnecessary products, such as an option or the like which is no longer needed.

First, as in Embodiment 1 through Embodiment 3, the server 105 receives the forwarded information 400 (FIG. 9) from the user side, and references the database 107 information shown in FIGS. 10A and 10B. Then, in a case where the configuration information 1006 indicates that the counter value 1012 for a specific construction (i.e., option) is lower than the counter threshold value 1016 by a given amount or more despite the installation of the given configuration (option) on the user side, the server 105 executes an optimum operation proposal indicating that the given construction (option) is not necessary.

Providing the function described above produces a special effect, namely that the presenting means can present the optimum image forming apparatus operation, including not only spec improvements but also spec reductions, to the user side.

### Other Embodiments

Note that, it goes without saying that the objectives of the present invention can also be achieved by providing a storage medium (or a recording medium) recording a program code of software for realizing the functions of the above-mentioned embodiments, to a computer (or a CPU or an MPU) of the system or the device that reads and executes the program code stored on the storage medium.

In such a case, the program code itself that was read out from the storage medium achieves the functions of the above-mentioned embodiments, whereby the storage medium storing the program code constitutes the recording medium.

Further, it goes without saying that the present invention includes not only the case where the program code that is read out by the computer is executed to realize the functions of the above-mentioned embodiments, but also a case where, based on the instructions in the program code, an operating system (OS) or the like running on the computer executes a portion of or all of the actual processing, whereby the processing realizes the functions of the above-mentioned embodiments.

Further, it goes without saying that the present invention also includes a case where the program code that is read out from the storage medium is written into a memory provided to a functions expansion card or to a functions expansion unit connected to the computer, and after that, based on the instructions in the program code, a CPU or the like provided in the functions expansion card or the functions expansion unit executes a portion of or all of the actually processing, and this processing realizes the functions of the above-mentioned embodiments.

As explained in the above-mentioned Embodiment 1 through Embodiment 8, according to the present invention, the operation method being used by the user, and the error information are learned, and the proposal for the better operation can be made quickly.

1-16. (canceled)

17. A proposing system for proposing a proposal with respect to an image forming apparatus, the image forming apparatus being capable of executing a print job which comprises a designation of a function of the image forming apparatus, the proposing system comprising:
a database that stores additional function information indicating a function which is addable to the image forming apparatus;
a recording unit that records a history of designation of a function which is inexecutable by the image forming apparatus;
a retrieving unit that retrieves additional function information from the database according to the designation of the inexecutable function recorded by the recording unit; and
a presenting unit that presents the additional function information retrieved by the retrieving unit to a user on a display.

18. A proposing system according to claim 17, wherein the retrieving unit retrieves the additional function information in case where a number of the recorded designation of the inexecutable function is higher than a predetermined value.

19. A proposing system according to claim 18, wherein the recording unit also records the history of designation of a function which is executable by the image forming apparatus, and
the presenting unit presents a proposal for specification reduction to remove the function in a case where a number of the recorded designation of the executable function is lower than a predetermined value.

20. A proposing system according to claim 17, further comprising an updating unit that updates the database in order to add new additional function information, wherein the retrieving unit retrieves the additional function information from the updated database based on the previously stored history.

21. A proposing system according to claim 17, wherein the designation of the inexecutable function includes a designation of a sheet size that is not mounted to the image forming apparatus, or a designation of a staple.

22. A proposing system according to claim 17, wherein the history is notified from a user apparatus which is one of an image forming apparatus and an external device capable of communicating with the image forming apparatus.

23. A proposing system according to claim 17, wherein the additional function information includes an optional equipment or software for the image forming apparatus.

24. A proposing method for proposing a proposal with respect to an image forming apparatus, the image forming apparatus being capable of executing a print job which comprises a designation of a function to the image forming apparatus, the proposing method comprising steps of:
storing additional function information indicating a function which is addable to the image forming apparatus to a database;
recording a history of designation of a function which is inexecutable by the image forming apparatus;
retrieving additional function information from the database according to the recorded designation of the inexecutable function; and
presenting the retrieved additional function information.

25. A proposing method according to claim 24, wherein the step of retrieving the additional function information is executed in a case where a number of occurrences of the recorded designation of the inexecutable function is higher than a predetermined value.

26. A proposing method according to claim 25, further comprising steps of:
recording a history of designation of a function which is executable by the image forming apparatus; and
presenting a proposal for specification reduction to remove the function in case where a number of the recorded designation of the executable function is lower than a predetermined value.

27. A proposing method according to claim 24, further comprising a step of updating the database in order to add new additional function information,
wherein the additional function information is retrieved from the updated database based on the previously recorded history.

28. A proposing method according to claim 24, wherein the designation of the inexecutable function includes a designation of a sheet size that is not mounted to the image forming apparatus or a designation of a staple.

29. A proposing method according to claim 24, wherein the history is notified from a user apparatus which is one of an image forming apparatus and an external device capable of communicating with the image forming apparatus.

30. A proposing method according to claim 24, wherein the additional function information includes an optional equipment or software for the image forming apparatus.

31. A computer-executable program stored on a computer-readable medium for proposing a proposal with respect to an image forming apparatus capable of executing a print job which comprises a designation of a function to the image forming apparatus, wherein the program makes the image forming apparatus execute the following:
processing for storing additional function information indicating a function which is addable to the image forming apparatus to a database;
processing for recording a history of designation of a function which is inexecutable by the image forming apparatus;
processing for retrieving additional function information from the database according to the recorded designation of the inexecutable function; and
processing for presenting the retrieved additional function information.

32. A computer-readable storage medium on which is stored a computer-executable program for proposing a proposal with respect to an image forming apparatus capable of executing a print job which comprises a designation of a function of the image forming apparatus, wherein the program makes the image forming apparatus execute the following:
processing for storing additional function information indicating a function which is addable to the image forming apparatus to a database;
processing for recording a history of designation of a function which is inexecutable by the image forming apparatus;
processing for retrieving the additional function information from the database according to the recorded designation of the inexecutable function; and processing for presenting the retrieved additional function information.
